(19) United States
(12) Patent Application Publication
(10) Pub. No.: US 2011/0215495 A1
(43) Pub. Date: Sep. 8, 2011

(54) Injection-Molding Process

(75) Inventors: Jens Menke, Allersberg (DE); Berenice Cottens, Besancon (FR)

(73) Assignee: FAURECIA KUNSTSTOFFE AUTOMOBILSYSTEME GMBH, Ingolstadt (DE)

(21) Appl. No.: 13/039,044

(22) Filed: Mar. 2, 2011

(30) Foreign Application Priority Data
Mar. 3, 2010 (DE) DE10 2010002549.6

(51) Int. Cl. B29C 45/76; B29C 45/14; B29C 45/03

(52) U.S. Cl. 264/40.1; 425/110

(57) ABSTRACT

The invention relates to an injection-molding process for producing a plastic molded part in a cavity of a tool. The process includes simultaneously injecting different melt streams composed of different component materials into the cavity, and controlling the injecting operation to obtain a form-fitting and/or material-bonding connection between the different component materials. The process further includes acquiring measurement data concerning the two melt streams at the site of development of the form-fitting and/or material-bonding connection and adapting the control to optimize the injecting operation on the basis of the measurements data acquired.

### CROSS-REFERENCE TO RELATED APPLICATION(S)

This application claims priority under 35 U.S.C. 119(a) from German application no. DE 10 2010 002 549.6 filed on Mar. 3, 2010.

### FIELD

The invention relates to an injection-molding process for producing a plastic molded part in a cavity of a tool, a computer program product and a device for carrying out an injection-molding process.

### BACKGROUND

Various injection-molding processes are known from the prior art. In general, injection molding is understood as meaning a process in which the polymer molding compound is prepared, for example in the form of plasticizing a polymer compound, and then injecting this plasticized polymer compound into a negative mold (cavity) of an injection-molding tool. After this polymer compound has cured, the desired injection-molded part is obtained.

DE 199 08 846 A1 discloses a method for producing plastic components by an injection-molding process in which at least two melt streams can be supplied in a cavity and in which materials are injected simultaneously or one after the other. The fast-moving streams approaching each other form a transitional region in which the flow fronts meet to form a solid bond.

### SUMMARY

In comparison, the invention is based on the object of providing an improved injection-molding process for producing a plastic molded part, a computer program product and an improved device for carrying out an injection-molding process.

The objects on which the invention are based are respectively achieved by the features of the independent patent claims. Preferred embodiments of the invention are specified in the dependent patent claims.

According to the invention, an injection-molding process for producing a plastic molded part in a cavity of a tool is provided, the process first comprising the step of simultaneously injecting into the cavity different melt streams composed of different component materials. Furthermore, the process comprises the step of controlling the injecting operation to obtain a form-fitting and/or material-bonding connection between the different component materials. Measurement data concerning the two melt streams are acquired at the site of development of the form-fitting and/or material-bonding connection and, on the basis of the measurement data acquired, an adaptation of the control is performed to optimize the setting operation.

Embodiments of the invention have the advantage that, for producing a corresponding plastic molded part using the injection-molding process, preferably no further mechanical elements, such as slides for example, are necessary to bring about the form-fitting and/or material-bonding connection between the different component materials. This connection between the different component materials is obtained exclusively by controlling the injecting operation, while an optimization of the injecting operation additionally takes place.

For example, it is possible that, during the injecting operation, it is determined on the basis of the measurement data that the two melt streams will probably not meet each other in the optimal way at the site of development of the form-fitting and/or material-bonding connection. In this case it is possible, by appropriate adaptation of the control, to optimize the injecting operation appropriately in the injection-molding process that is in progress. Furthermore, these measurement data can also be used for the purpose of carrying out the injecting operation in an optimized way in a subsequent injection-molding process for a further plastic molded part to be formed in the same cavity.

According to one embodiment of the invention, the site of development of the form-fitting and/or material-bonding connection is a spatially predetermined and spatially delimited first region of the cavity in the form of a surface area. In other words, the simultaneous injection of the different melt streams does not cause any undefined mixing with a zone of intermixing that extends over a large area, but instead the form-fitting and/or material-bonding connection forms in an actually spatially predetermined and also spatially delimited first region of the cavity in the form of a surface area. The ‘form of a surface area’ is understood here as meaning that, although the region may be three-dimensional, the direction of extent in the third dimension is much less than in the other two dimensions of this spatial region.

According to one embodiment of the invention, the acquisition of the measurement data concerning the two melt streams at the site of development comprises measurement data acquisition directly at spatial positions adjacent to both sides of the first region of the cavity in the form of a surface area. In other words, an essential concept of this embodiment is that measurement data acquisition is performed on both sides of the melt streams directly at the site of development of the form-fitting and/or material-bonding connection.

On the one hand, in this way it can be optimally ascertained whether the development or formation of the form-fitting and/or material-bonding connection is taking place in the desired way. On the other hand, it makes it possible to dispense with sophisticated measurements at a large number of further measuring points in the cavity, since sufficiently helpful information concerning the injecting operation taking place can be obtained by the measurement data acquisition at the said site of development. This is also relevant in particular against the background that measuring methods that require direct contact with the melt streams may suffer from a change in the measuring sensitivity of corresponding sensors over time as a result of the high temperatures of the melt streams. If, as a result, measurement data acquisition is restricted just to the region of the cavity in which the form-fitting and/or material-bonding connection of the different component materials takes place, this change in the measuring sensitivity can be prevented by regularly exchanging the limited number of sensors located there, notwithstanding the problem that the overall operating costs of the corresponding injection-molding process are increased significantly by exchanging a large number of sensors present in the cavity.

Consequently, the acquisition of the measurement data concerning the two melt streams is preferably restricted to the spatial regions that are directly adjacent to the two sides of the first region of the cavity in the form of a surface area.

According to a further embodiment of the invention, the measurement data comprise temperature values and/or pressure values and/or flow rates and/or viscosity values of the melt streams. This makes it possible to adapt the control to optimize the injecting operation in a reliable way.

According to a further embodiment of the invention, the acquisition of the measurement data is performed by means of a number of sensors, each melt stream being assigned at least one sensor. The sensors are preferably sensors for wireless acquisition of the measurement data. Since the sensors consequently do not come into contact with the hot melt streams, corresponding impairment of the sensors as a result of heat exposure and/or chemical reactions with the sensors is reliably avoided. This ensures consistent functionality of the described process over a relatively long period of time.

It should be noted that it is also preferred in this embodiment that the acquisition of the measurement data concerning the two melt streams at the site of development is a measurement data acquisition at spatial positions that are directly adjacent to the two sides of the first region of the cavity in the form of a surface area. As already mentioned above, the invention is based on the realization that measurement data acquisition that is restricted to spatial positions adjacent to these two sides of the first region of the cavity in the form of a surface area is sufficient for performing an adaptation of the control to optimize the injecting operation. This allows the overall number of sensors required to be minimized, irrespective of whether the sensors are sensors which require contact with the melt stream or wireless sensors for wireless acquisition of the measurement data.

According to a further embodiment of the invention, the control of the injecting operation comprises individual control of the injecting operation of the individual melt streams. It should be pointed out in this connection that the term “simultaneous injection” is not necessarily understood as meaning that the actual operation of injecting is initiated at exactly the same point in time. It is understood in general as meaning that simultaneous injection of the different melt streams composed of the different component materials into the cavity takes place over a predefined time period. The initiation of the respective injecting operation can however be individually controlled with respect to time. However, corresponding controls of the injecting operation are not restricted only to the point in time of the initiation of the injecting operation but also comprise individual control of the melt streams with respect, for example, to temperature, through-flow, viscosity and/or pressure.

According to a further embodiment of the invention, the process also comprises the step of calibrating the injecting operation by controlling the injecting operation to obtain the desired form-fitting and/or material-bonding connection at the site of development, while the adaptation of the control is a corrective control based on the calibrated injecting operation.

A corresponding calibration may be carried out in this case in various ways. Possible, for example, is a calibration by conducting a series of corresponding experimental tests. Preferred, however, is a calibration carried out by using corresponding mathematical models, by means of which the injecting operation can be modelled and whereby the individual control of the injecting operation of the individual melt streams is established.

Once an injecting operation has been calibrated, however, it may happen that, as a result of an overall warming up of the injection-molding system, the temperatures of the corresponding melt streams as so high after a number of injection-molding operations that the desired injection-molding result is no longer achieved at the site of development of the form-fitting and/or material-bonding connection. By means of the measurement data acquisition, minor deviations from the desired result can be detected in good time, so that, when there is an incipient deviation from the desired result, corrective control based on the previously calibrated injecting operation is possible.

According to a further embodiment of the invention, the process also comprises the step of providing a main element in the cavity, the control of the injecting operation also comprising control of the injecting operation to obtain a form-fitting and/or material-bonding connection of one of the component materials to the surface of the main element at the first and/or a second spatially predetermined and spatially delimited region of the cavity in the form of a surface area. In other words, the described process serves not only for the purpose of achieving a connection between the two component materials but also a connection of one of the component materials or even both component materials to the surface of a main element that is additionally provided in the cavity. In this way it is possible, for example, for the main element to be encapsulated in a specific way. This makes it possible, for example, that a specific material cohesion takes place between the main element and the two component materials at a spatially predetermined and spatially delimited region in the form of a surface area.

In a further aspect, the invention relates to a computer program product with instructions that can be performed by a processor for carrying out the aforementioned process steps of the process for producing a plastic molded part.

In a further aspect, the invention relates to a device for carrying out an injection-molding process, the device having a cavity for producing a plastic molded part, two separate melt flow-way systems for the cavity and two separate injecting units, each melt flow-way system being assigned one of the injecting units, the injecting units being designed to inject two different melt streams composed of different component materials into the cavity simultaneously by way of the melt flow-way systems. Furthermore, the device has a control device, the control device being designed for controlling the injecting operation to obtain a form-fitting and/or material-bonding connection between the component materials. Furthermore, sensors are provided for acquiring measurement data concerning the two melt streams at least at the site of development of the form-fitting and/or material-bonding connection, the control device also being designed for adapting the control to optimize the injecting operation on the basis of the measurement data acquired.

According to one embodiment of the invention, the control device can be calibrated for controlling the injecting operation to obtain the desired form-fitting and/or material-bonding connection at the site of development, the control also being designed for the purpose of carrying out the adaptation of the control by a corrective control based on the calibrated injecting operation.

According to one embodiment of the invention, the device is also designed for acquiring measurement data concerning the two melt streams at the site of development at spatial positions adjacent to both sides of the first region of the cavity in the form of a surface area.

### BRIEF DESCRIPTION OF THE DRAWINGS

Preferred embodiments are explained in more detail below on the basis of the drawings, in which:

FIG. 1 shows a block diagram of an injection-molding device,

FIG. 2 shows a flow diagram of an injection-molding process for producing a plastic molded part in a cavity of a tool.

### DETAILED DESCRIPTION OF ILLUSTRATIVE EMBODIMENTS

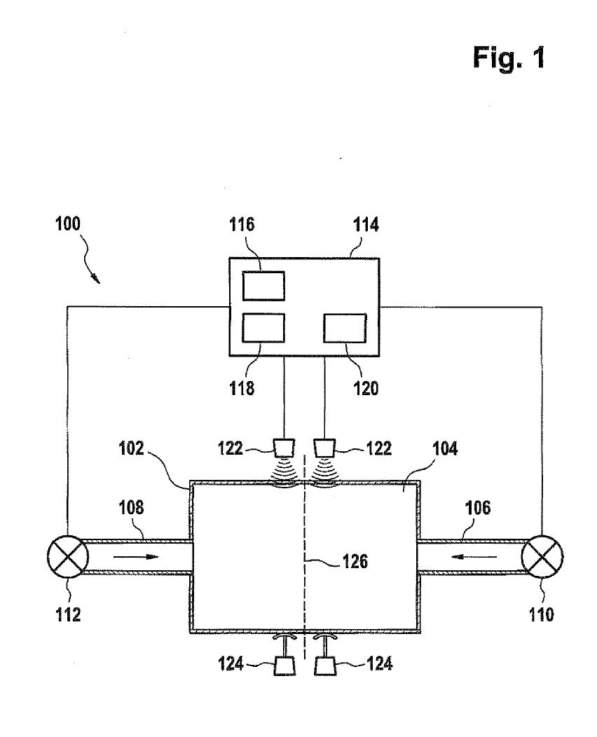

FIG. 1 shows a block diagram of an injection-molding device, the injection-molding device being a multi-component injection-molding tool 100. The multi-component injection-molding tool 100 comprises at least two separate melt flow-way systems 106 and 108, by means of which simultaneous injection of different plastics into a cavity 104 of the injection molding tool 100 is possible. For this purpose, the tool 100 has two separate injecting units 110 and 112, the melt flow-way system 106 being assigned the injecting unit 110 and the melt flow-way system 108 being assigned the injecting unit 112. The injecting units 110 and 112 are designed for the purpose of injecting two different melt streams composed of different component materials into the cavity 104 by way of the melt flow-way systems 106 and 108, as indicated by the corresponding arrows.

The aim is to obtain with the tool 100 an injection-molded component which has at a predefined location a form-fitting and/or material-bonding connection between the two component materials that have been injected by means of the injecting units 110 and 112. For example, this component may be a motor vehicle front end.

Not shown in FIG. 1 is the possibility that a main element of the component to be produced can be inserted into the cavity 104, which is relevant in particular whenever the main element consists of a number of parts and these individual parts are to be connected to one another by means of a number of parts made of thermoplastic materials. In this case, it is possible that the component materials of the melt streams from melt flow-way systems 106 and 108 are molded on simultaneously at different locations of the component.

The tool 100 also has a control device 114, the control device 114 being designed for controlling the injecting operation to obtain the form-fitting and/or material-bonding connection between the component materials. Sensors 122 at 124 serve for acquiring measurement data concerning the two melt streams of the melt flow-way systems 106 and 108 at least at the site of development 126 of the form-fitting and/or material-bonding connection, and the control device 114 is designed for adapting the optimization of the control of the injecting operation on the basis of the measurement data acquired.

The control device 114 itself has, inter alia, a processor 116 and a memory 118. In the memory 118 there may be contained, for example, calibration data, by means of which the control device 114 is programmed such that the injecting units 110 and 112 are activated by the control device 114 by way of corresponding control lines in such a way that the two component materials meet each other in the desired way at the site of development 126, so that the desired form-fitting and/or material-bonding connection of the materials takes place at the site of development 126.

The control device also comprises an interface 120, by way of which the injecting units 110 and 112 as well as the sensors 122 and 124 and the control device 114 can communicate for the transfer of data, for example of measurement data.

In FIG. 1, only one possibility for communication of the control device to the injecting units 110 and 112 is shown. However, this should not be understood as a restriction of the generality. Any technical unit of an injection-molding machine can be controlled by the control device, such as, for example, plasticizing units, heating units, units by means of which a finished workpiece produced in the cavity 104 can be automatically removed after a predefined time, as well as generally units involved in providing the various component materials.

In FIG. 1, altogether four sensors 122 and 124 are shown. The sensors 122 are wireless sensors, while the sensors 124 are sensors with contacts, and are consequently in direct contact with the melt streams of the melt flow-way systems 106 and 108. As indicated in FIG. 1, the acquisition of the measurement data concerning the two melt streams is performed at spatial positions adjacent to the two sides of the region of the site of development 126. The sensors 122 and 124 are in this case arranged exclusively along this region in the form of a surface area, which is sufficient to obtain a reliable adaptation of the control to optimize the injecting operation on the basis of the measurement data acquired.

For example, it could be found after several injection-molding operations, by means of which corresponding plastic molded parts have been produced in the cavity 102, that the two melt streams from melt flow-way systems 106 and 108 arrive in the region (site of development 126) with a certain time disparity. If, for example, the melt stream arrived at the region 126 with a time disparity before the melt stream from melt flow-way system 108, this would have the effect that the region (or site of development 126) would be displaced to the left in FIG. 1. In this case, the sensors 122 and 124 do not detect a simultaneous arrival of the approaching polymer components but an arrival with a time disparity. The measured time difference can then be used by the control device for activating the corresponding injecting units 110 and 112 in an optimized way such that the time difference for the arrival of the approaching polymer components becomes 0.

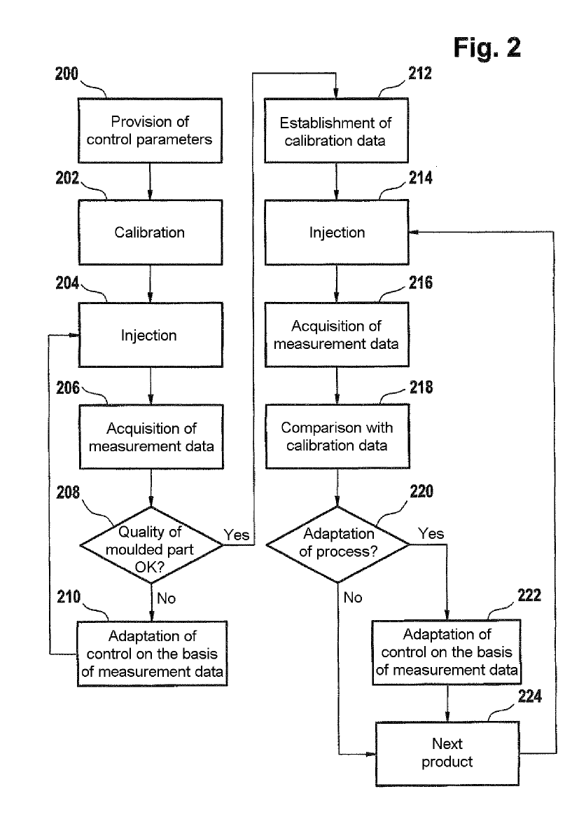

FIG. 2 shows an injection-molding process for producing a plastic molded part in a cavity of a tool. The process begins in step 200 with the provision of corresponding control parameters, which may be obtained, for example, in theoretical simulations with respect to a desired workpiece and a desired form of cavity to control a corresponding injecting operation. These control parameters are then provided in step 202 as preliminary calibration data.

However, optimal control parameters, i.e. calibration data to obtain the desired injection-molding result, may be additionally determined in optional experimental calibrating tests.

This is accomplished by beginning with step 204, in which the different melt streams composed of the different component materials are injected into the cavity. The injecting operation is controlled on the basis of the preliminary calibration data in such a way that the desired form-fitting and/or material-bonding connection between the different component materials of the melt streams is obtained.

During the injecting operation, the acquisition of measurement data concerning the two melt streams at the site of development of the form-fitting and/or material-bonding connection is performed in step 206. Once the injection-molding operation has been completed, a check is performed in step 208 to ascertain whether the quality of the plastic molded part obtained is sufficient. For example, it may be checked whether a material-bonded connection that has developed between different component materials has sufficient stability, or whether the two component materials merely adjoin each other loosely.

The desired quality of the molded part is usually already achieved on the basis of the preliminary calibrating operation in steps 200 and 202. If this is not the case, however, the checking step 208 is followed by the step 210, in which an adaptation of the control is performed on the basis of the measurement data and possibly on the basis of the detected quality of the molded part. With this adapted control, the process then returns to step 204 and the steps of injecting, acquiring the measurement data (206) and checking the quality of the molded part (step 208) are repeated. Only when it has been definitely ensured that a desired quality of the molded part can be achieved on the basis of the optimized control parameters are the calibration data finally established in step 212.

It should be pointed out that these calibration data are optimal control parameters for obtaining the form-fitting and/or material-bonding connection of the two component materials in a predefined spatial region of the cavity of the corresponding injection-molding tool.

The following steps 214-224 then describe that part of the injection-molding process in which plastic molded parts can be produced in a mass production process. This process begins in step 214 with the simultaneous injection of the component materials into the two melt flow-way systems, after which the component materials are directed into the cavity by way of the melt flow-way systems. Sensors then acquire measurement data concerning the two melt streams, at least at the site of development of the form-fitting and/or material-bonding connection (step 216).

By comparison with the calibration data established in step 212, it can then be determined in step 218 whether there is a deviation from the optimum injecting operation, for example as a result of temperature or pressure fluctuations.

This is followed in step 220 by a decision-finding operation, as to whether the injection process is being adapted in an appropriate way, for example by an adaptation of the control of the injecting operation in the form of a corrective control on the basis of the calibrated injecting operation. If an adaptation of the process is necessary in step 220, this is followed in step 222 by an adaptation of the control on the basis of the measurement data acquired in step 216 and the process ends initially in step 224, in which the desired injection-molded product is completed and the cavity is ready for renewed reception of the two melt streams for producing a further injection-molded product.

The adaptation used in step 222 of the control of the injecting operation on the basis of the measurement data is in this case used for the injecting operation 214 of the next injection-molded product.

If, however, the result of the decision-finding operation in step 220 is that an adaptation of the process is not necessary, i.e. the control of the injecting operation is already optimal, the process ends directly in step 224 with the completion of the injection-molded product and the cavity is ready for renewed reception of the melt streams in step 214, without an adaptation of the control on the basis of the measurement data having been necessary for this.

Although the present invention has been described with reference to preferred embodiments, workers skilled in the art will recognize that changes may be made in form and detail without departing from the scope of the invention.

### LIST OF DESIGNATIONS

100 injection-molding device

100 injection-molding tool

104 cavity

106 melt stream

108 melt stream

110 injecting unit

112 injecting unit

114 control device

116 processor

118 memory

120 interface

122 wireless sensor

124 sensor with contacts

126 site of development of the form-fitting and/or material-bonding connection

What is claimed is:

1. An injection-molding process for producing a plastic molded part in a cavity of a tool, the process comprising:
simultaneously injecting different melt streams composed of different component materials into the cavity;
controlling the injecting operation to obtain a form-fitting and/or material-bonding connection between the different component materials;
acquiring measurement data concerning the different melt streams at a site of development of the form-fitting and/or material-bonding connection; and
adapting the control to optimize the injecting operation in response to acquiring the measurements data.

2. The process according to claim 1, wherein the site of development of the form-fitting and/or material-bonding connection being a spatially predetermined and spatially delimited first region of the cavity in a form of a surface area.

3. The process according to claim 2, wherein acquiring the measurement data concerning the different melt streams at the site of development comprises acquiring the measurement data at spatial positions directly adjacent to two sides of the first region of the cavity in the form of the surface area.

4. The process according to claim 1, where the measurement data comprises at least one of temperature values, pressure values, flow rates, and viscosity values of the different melt streams.

5. The process according to claim 1, wherein the acquisition of the measurement data is performed by means of a number of sensors, each of the different melt streams being assigned at least one sensor.

6. The process according to claim 5, wherein the sensors comprise sensors for wireless acquisition of the measurement data.

7. The process according to claim 1, wherein controlling the injecting operation comprises individually controlling the injecting operation of the different melt streams.

8. The process according to claim 1, wherein controlling the injecting operation comprises controlling at least one of an injecting time, an injecting pressure, and an injecting temperature of the different melt streams.

9. The process according to claim 1, further comprising:
calibrating the injecting operation by controlling the injecting operation to obtain the form-fitting and/or material-bonding connection at the site of development; and
wherein adapting the control comprises applying a corrective control in response to calibrating the injecting operation.

10. The process according to claim 1, further comprising providing a main element in the cavity;
wherein controlling the injecting operation further comprises controlling the injecting operation to obtain a form-fitting and/or material-bonding connection of one of the different component materials at the surface of the main element at a first and/or a second spatially predetermined and spatially delimited region of the cavity in a form of a surface area.

11. A computer readable medium embodying instructions that, when executed by a processor, cause the processor to perform a process comprising:
simultaneously injecting different melt streams composed of different component materials into the cavity;
controlling the injecting operation to obtain a form-fitting and/or material-bonding connection between the different component materials;
acquiring measurement data concerning the different melt streams at a site of development of the form-fitting and/or material-bonding connection; and
adapting the control to optimize the injecting operation in response to acquiring the measurements data.

12. The computer readable medium of claim 11, wherein the site of development of the form-fitting and/or material-bonding connection being a spatially predetermined and spatially delimited first region of the cavity in a form of a surface area.

13. The computer readable medium of claim 12, wherein acquiring the measurement data concerning the different melt streams at the site of development comprises acquiring the measurement data at spatial positions directly adjacent to two sides of the first region of the cavity in the form of the surface area.

14. The computer readable medium of claim 11, where the measurement data comprises at least one of temperature values, pressure values, flow rates, and viscosity values of the different melt streams.

15. The computer readable medium of claim 11, wherein the acquisition of the measurement data is performed by means of a number of sensors, each of the different melt streams being assigned at least one sensor.

16. The computer readable medium of claim 11, wherein controlling the injecting operation comprises individually controlling the injecting operation of the different melt streams.

17. The computer readable medium of claim 11, wherein controlling the injecting operation comprises controlling at least one of an injecting time, an injecting pressure, and an injecting temperature of the different melt streams.

18. The computer readable medium of claim 1, further comprising:
calibrating the injecting operation by controlling the injecting operation to obtain the form-fitting and/or material-bonding connection at the site of development; and
wherein adapting the control comprises applying a corrective control in response to calibrating the injecting operation.

19. A device for carrying out an injection-molding process, the device comprising:
a cavity for producing a plastic molded part;
two separate melt flow-way systems for the cavity;
two separate injecting units, each of the two separate melt flow-way systems being assigned one of the injecting units, the two separate injecting units being designed to inject two different melt streams composed of different component materials into the cavity simultaneously by way of the two separate melt flow-way systems,
a control device, the control device being designed for controlling the injecting operation to obtain a form-fitting and/or material-bonding connection between the component materials,
sensors for acquiring measurement data concerning the two melt streams at least at a site of development of the form-fitting and/or material-bonding connection, the control device also being designed for adapting the control to optimize the injecting operation on the basis of the measurement data acquired.

20. The device according to claim 19, wherein the control device is capable of being calibrated for controlling the injecting operation to obtain the form-fitting and/or material-bonding connection at the site of development, the control device also being designed for the purpose of carrying out adaptation of the control by a corrective control based on the calibration.
